(19) United States
(12) Patent Application Publication
(10) Pub. No.: US 2025/0121603 A1
(43) Pub. Date: Apr. 17, 2025

(54) INK CONTAINER

(71) Applicant: SEIKO EPSON CORPORATION, Tokyo (JP)

(72) Inventors: Yuta KOIKE, Matsumoto-shi (JP); Tadahiro MIZUTANI, Shiojiri-shi (JP); Tadashi WATANABE, Matsumoto-shi (JP)

(73) Assignee: SEIKO EPSON CORPORATION, Tokyo (JP)

(21) Appl. No.: 18/916,873

(22) Filed: Oct. 16, 2024

(30) Foreign Application Priority Data
Oct. 17, 2023 (JP) 2023-178714

(51) Int. Cl. B41J 2/175

(52) U.S. Cl. CPC B41J 2/17553; B41J 2/17509; B41J 2/17513; B41J 2/17523

(57) ABSTRACT

An ink container includes a liquid-contact section and a liquid-non-contact section. The liquid-contact section is made of a virgin plastic material and is to be in contact with ink in the ink container. The liquid-non-contact section is made of a material containing recycled plastics and is to be kept from contact with the ink.

The present application is based on, and claims priority from JP Application Serial Number 2023-178714, filed Oct. 17, 2023, the disclosure of which is hereby incorporated by reference herein in its entirety.

### BACKGROUND

### 1. Technical Field

The present disclosure relates to techniques concerning ink containers.

### 2. Related Art

Ink-refill ink jet printers equipped with refillable ink tanks are known. An ink container disclosed in JP-A-2022-18712 is intended for use in refilling a refillable ink tanks with ink.

In recent years, there has been a demand for ink containers made of recycled plastics, which are preferred from the viewpoint of a recycling-oriented society. However, it is difficult to determine the composition of recycled plastics obtained by reprocessing waste plastics in which different kinds of plastics are mixed. The inventors have found that such an ink container made of recycled plastics can dissolve into the ink kept therein and can therefore affect the ink.

### SUMMARY

According to an aspect of the present disclosure, an ink container is provided. The ink container includes a liquid-contact section and a liquid-non-contact section. The liquid-contact section is made of a virgin plastic material and is to be in contact with ink in the ink container. The liquid-non-contact section is made of a material containing recycled plastics and is to be kept from contact with the ink.

### BRIEF DESCRIPTION OF THE DRAWINGS

FIG. 1 is a perspective view of a printer.

FIG. 2 is a perspective view of ink tanks being refilled with ink supplied from an ink container.

FIG. 3 is a front view of the ink container in the upright position.

FIG. 4 is a perspective view of the inside of a cap.

FIG. 5 is a perspective view of an ink outlet portion in a second embodiment.

FIG. 6 is a perspective view of an ink outlet portion in a third embodiment.

FIG. 7 is a perspective view of the inside of a cap in the third embodiment.

FIG. 8 is a front view of a main body in a fourth embodiment.

FIG. 9 is a perspective view of the inside of an ink outlet portion in a fourth embodiment.

FIG. 10 is a sectional view of a main body in a fifth embodiment.

FIG. 11 is a sectional view of a main body in a sixth embodiment.

FIG. 12 is a perspective view of a variation of the ink outlet portion.

### DESCRIPTION OF EMBODIMENTS

### A. First Embodiment

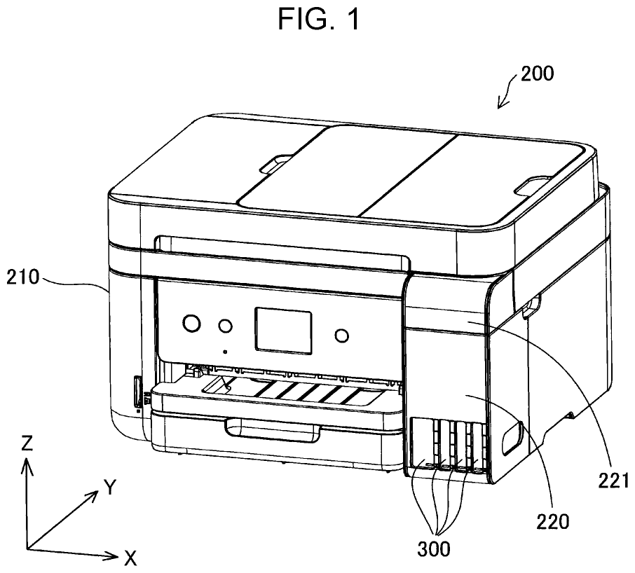

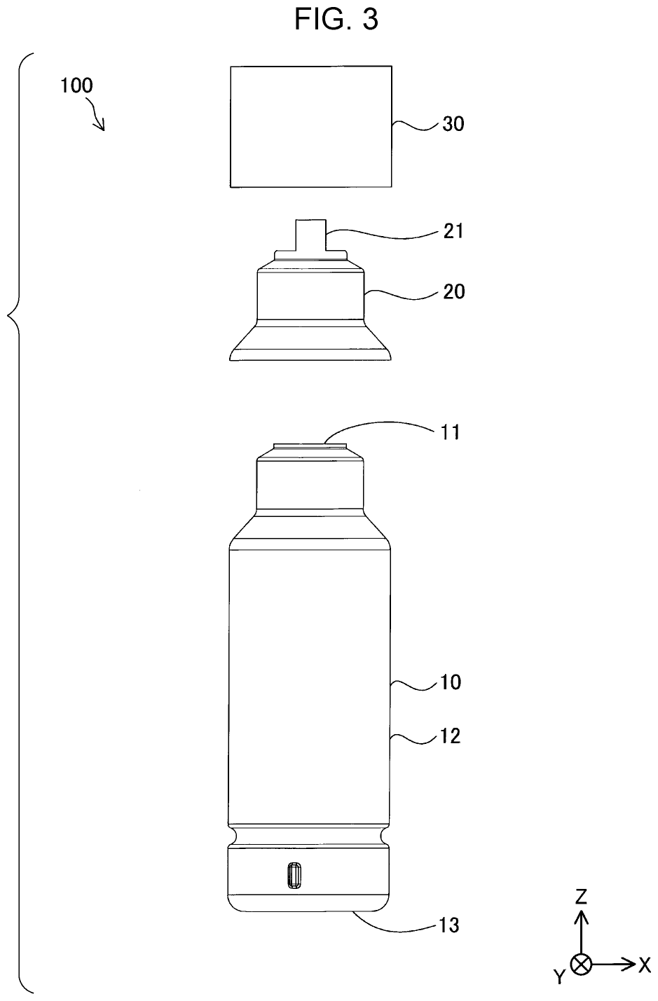

FIG. 1 is a perspective view of a printer 200 according to the present embodiment. The printer 200 is an ink jet printer that performs printing by ejecting ink onto a printing medium. X, Y, and Z in FIG. 1 denote axes that are orthogonal to each other. The X-axis coincides with the width direction of the printer 200. The Y-axis coincides with the depth direction of the printer 200. The Z-axis coincides with the height direction of the printer 200. The printer 200 is installed on a horizontal plane defined by the X-axis direction and the Y-axis direction. These axes in FIG. 1 coincide with the respective axes in FIG. 3.

The printer 200 includes a housing 210. The housing 210 accommodates a carriage (not illustrated) capable of moving in the primary scanning direction (the X-axis direction). The carriage is equipped with a print head from which ink is ejected and sprayed onto a printing medium. An ink tank housing unit 220, in which ink tanks 300 are housed, is located in an end portion of the front side of the housing 210. The ink tank housing unit 220 is fitted with a lid 221, which can be opened and closed at the top of the ink tank housing unit 220. The ink tanks 300 are refillable ink tanks, each of which is to be refilled with ink kept in an ink container 100 when the ink level is low.

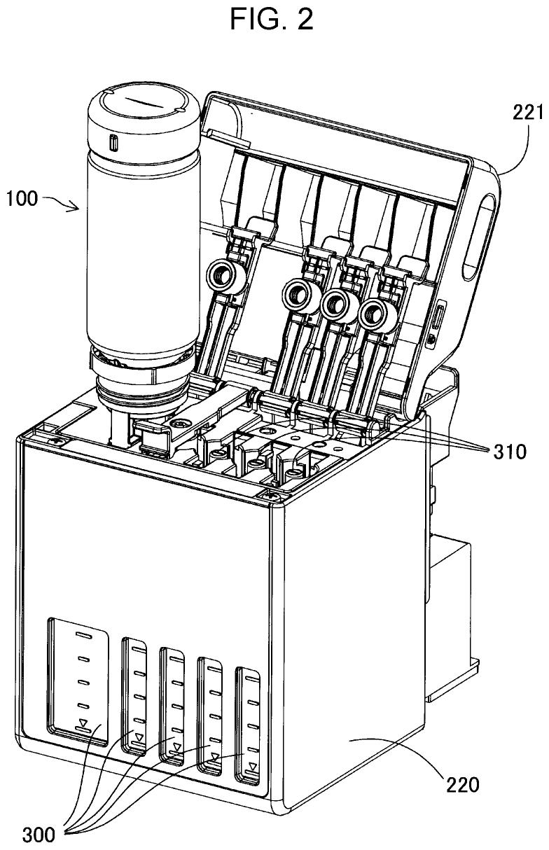

FIG. 2 is a perspective view of the ink tanks 300 being refilled with ink supplied from the ink container 100. The front side of each of the ink tanks 300 is a transparent or translucent member where the amount of ink remaining ink in each of the ink tanks 300 is visible from the outside. When the ink level is low, the lid 221 may be opened as illustrated in FIG. 2 so that the ink tanks 300 can be refilled with ink through the respective ink inlet channel members, which are denoted by 310.

FIG. 3 is a front view of the ink container 100 in the upright position. The ink container 100 in the upright position refers to the state in which the ink container 100 including a main body 10 having a bottom portion 13 is set on a horizontal surface of, for example, a desk with the bottom portion 13 facing down. As illustrated in FIG. 2 mentioned above, the ink tanks 300 are each filled with ink supplied through the tip of the ink container 100 turned upside-down. Ink that is to be supplied to the ink tanks 300 is kept in the ink container 100.

The ink container 100 includes a liquid-contact section and a liquid-non-contact section. The liquid-contact section is to be in contact with ink in the ink container 100, and the liquid-non-contact section is to be kept from contact with the ink. The liquid-contact section is made of a virgin plastic material. The virgin plastic material is a new plastic material produced without other components added to it. The liquid-contact section is made of a virgin plastic material that does not dissolve into ink kept in the container. The liquid-non-contact section is made of a material containing recycled plastics. Recycled plastics are produced from waste plastics. Thus, different kinds of plastics are mixed in the recycled plastics. The material containing recycled plastics may be a material composed solely of recycled plastics or may be a material that is a mixture of a virgin plastic and recycled plastics. The liquid-contact section in the present embodiment includes the main body 10, an ink outlet portion 20, and one part of a cap 30, which are described below. The liquid-non-contact section is the other part of the cap 30, which is described below.

The ink container 100 in the present embodiment includes the main body 10, the ink outlet portion 20, and the cap 30. The main body 10 is a member in which ink can be kept. The main body 10 is a member that defines the shape of a cylindrical bottle and has an open portion 11, the bottom portion 13, and a side portion 12. The open portion 11 is linked to the ink outlet portion 20. The open portion 11 and the bottom portion 13 are coupled to each other with the side portion 12 extending therebetween.

The ink outlet portion 20 is a member coupled to the main body 10 to enable the ink to flow out of the ink container 100. The ink outlet portion 20 has a cylinder portion 21 with an ink outlet channel defined therein. Each ink tank 300 is refilled with ink in a state in which the corresponding ink inlet channel member 310 is inserted in the cylinder portion 21. A valve (not illustrated) is attached to the inside of the cylinder portion 21. The valve opens when the ink inlet channel member 310 is inserted into the cylinder portion 21. The valve closes when the ink inlet channel member 310 is removed from the cylinder portion 21. The ink outlet portion 20 in the present embodiment is a member separate from the main body 10. The ink outlet portion 20 is attached to the main body 10. The cap 30 is a member attached to the ink outlet portion 20. The cap 30 in the present embodiment covers the ink outlet portion 20 when being attached to the ink outlet portion 20.

FIG. 4 is a perspective view of the inside of the cap 30. The cap 30 is a member including a first sealing portion 31, with which the ink outlet portion is sealed. With the cap 30 being attached to the ink outlet portion 20, the ink outlet portion 20 and the first sealing portion 31 are in contact with each other, in which state the first sealing portion 31 keeps ink from leaking out. The first sealing portion 31 is part of the liquid-contact section. This means that the first sealing portion 31 is made of a virgin plastic material. The cap 30 except for the first sealing portion 31 is the liquid-non-contact section. This means that the cap 30 except for the first sealing portion 31 is made of a material containing recycled plastics.

In the present embodiment, a material containing recycled plastics that can dissolve in ink in the ink container 100 is kept from contact with the ink as described above. This eliminates or reduces the possibility that the ink container 100 will become dissolved through contact with the ink. Thus, the material concerned is less likely to have adverse effects on the ink kept in the container.

The first sealing portion 31 is part of the liquid-contact section of the ink container 100, and the cap 30 except for the first sealing portion 31 is the liquid-non-contact section of the ink container 100. The material containing recycled plastics is therefore kept from contact with ink. This eliminates or reduces the possibility that the cap 30 will become dissolved through contact with ink. Thus, the material concerned is less likely to have adverse effects on the ink kept in the container.

### B. Second Embodiment

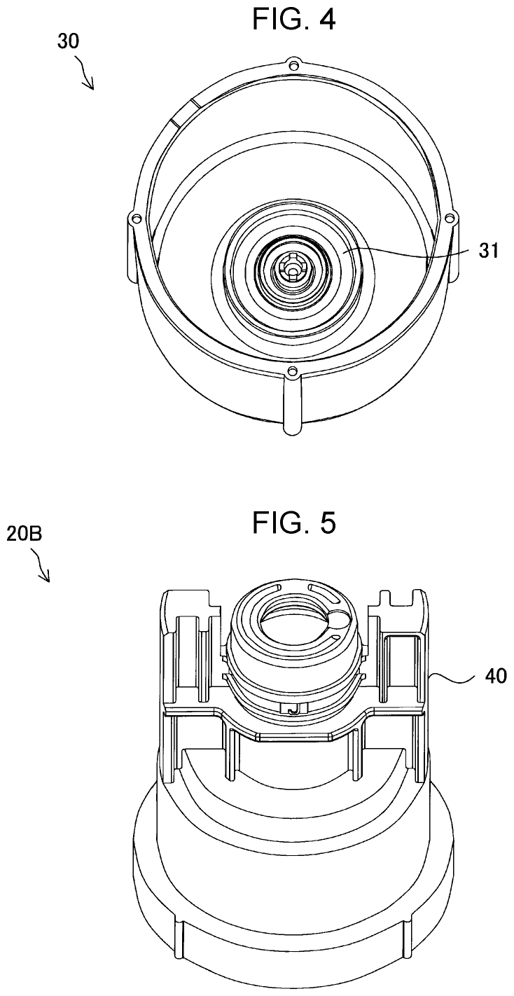

FIG. 5 is a perspective view of an ink outlet portion 20B in a second embodiment. The ink outlet portion 20B includes an identification portion 40. The ink container 100 according to the second embodiment is otherwise structurally identical to the ink container 100 according to the first embodiment.

The identification portion 40 is disposed in at least a part of the outer surface region of the ink outlet portion 20 to enable identification of the type of ink. In the present embodiment, identification portions 40 of different shapes are provided for different types of ink. It is not required that the shapes of the identification portions 40 for the respective types of ink vary to the extent readily discernible to the eyes. For example, each of the identification portions 40 is shaped such that it fits into a recess extending along the periphery of the ink inlet channel member 310 of the corresponding one of the ink tanks 300, in which case it is required that the shapes of the identification portions 40 for the respective types of ink vary to the extent that each identification portion 40 does not fit into the ink inlet channel members 310 of the ink tanks 300 other than the corresponding ink tank 300. More specifically, the identification portion 40 of the ink container 100 for replenishment of yellow ink is shaped such that it fits into the recess provided for the ink tank 300 for keeping yellow ink therein, whereas the identification portion 40 of the ink container 100 for replenishment of another color ink, such as magenta ink or cyan ink, is shaped such that it does not fit into the recess provided for the ink tank 300 for keeping yellow ink therein. The identification portion 40 is included in the liquid-non-contact section. This means that the identification portion 40 is made of a material containing recycled plastics.

In the ink container 100 according to the second embodiment described above, the identification portion 40 that does not come into contact with ink is made of a material containing recycled plastics. The material containing recycled plastics is therefore kept from contact with ink. This eliminates or reduces the possibility that the material will become dissolved through contact with ink. Thus, the material concerned is less likely to have adverse effects on the ink kept in the container.

### C. Third Embodiment

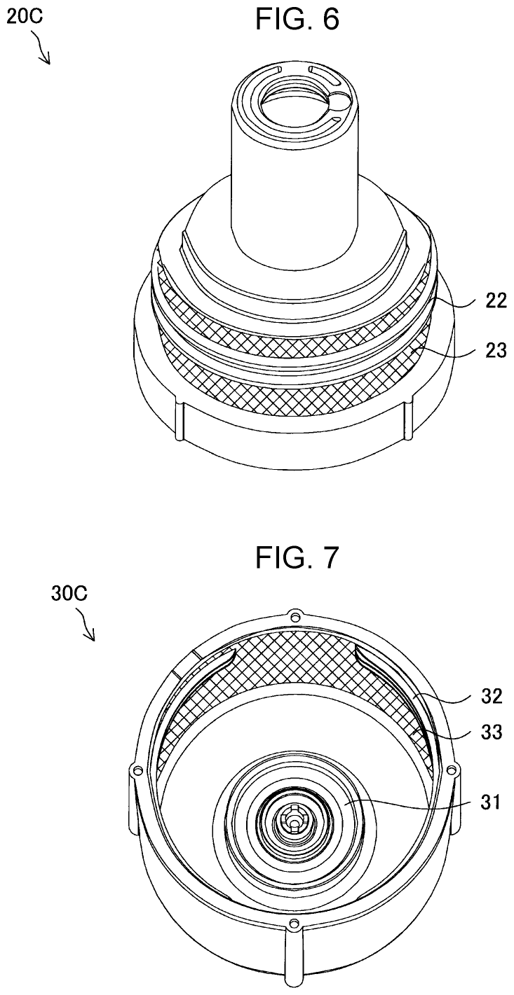

FIG. 6 is a perspective view of an ink outlet portion 20C in a third embodiment. FIG. 7 is a perspective view of the inside of a cap 30C in the third embodiment. The ink outlet portion 20C includes a first engagement portion 22, and the cap 30C includes a second engagement portion 32. The ink container 100 according to the third embodiment is otherwise structurally identical to the ink container 100 according to the first embodiment.

The first engagement portion 22 extends along the periphery of the ink outlet portion 20C. The first engagement portion 22 engages with the second engagement portion 32. That is, the ink outlet portion 20C engages with the cap 30C via the first engagement portion 22 and the second engagement portion 32. The concept of “engagement” herein includes not only the state in which one member engages with the other member but also the state in which one member is screwed into the other member. In the present embodiment, the first engagement portion 22 and the second engagement portion 32 engage with each other, with one being screwed into the other, and as a result, the ink outlet portion 20C engages with the cap 30C. The first engagement portion 22 and the second engagement portion 32 are included in the liquid-non-contact section. This means that the first engagement portion 22 and the second engagement portion 32 are each made of a material containing recycled plastics.

The ink outlet portion 20C in the present embodiment includes a wall 23 in the region where the first engagement portion 22 is located. The wall 23 is part of the first engagement portion 22 and is included in the liquid-non-contact section. The outer peripheral surface of the wall 23 is a crosshatched section in FIG. 6.

The cap 30C in the present embodiment includes a wall 33 in the region where the second engagement portion 32 is located. The wall 33 is part of the second engagement portion 32 and is included in the liquid-non-contact section. The inner peripheral surface of the wall 33 is a crosshatched section in FIG. 7. The thread in the second engagement portion 32 extends discontinuously in the circumferential direction. Alternatively, the thread may extend with no gap between one part and another part of it in the circumferential direction.

In the ink container 100 according to the third embodiment described above, the first engagement portion 22 and the second engagement portion 32 that do not come into contact with ink are each made of a material containing recycled plastics. The material containing recycled plastics is therefore kept from contact with ink. This eliminates or reduces the possibility that the material will become dissolved through contact with ink. Thus, the material concerned is less likely to have adverse effects on the ink kept in the container.

### D. Fourth Embodiment

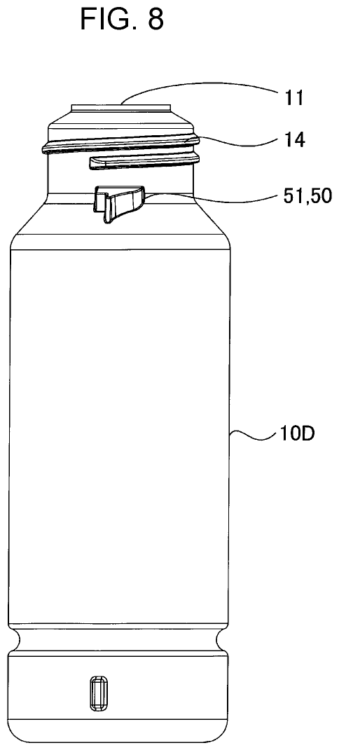

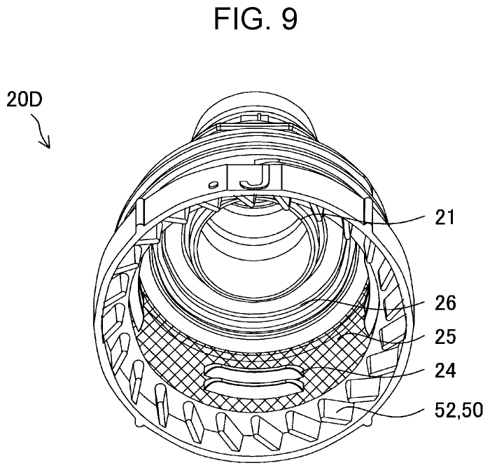

FIG. 8 is a front view of a main body 10D in a fourth embodiment. FIG. 9 is a perspective view of the inside of an ink outlet portion 20D in the fourth embodiment. The ink container 100 according to the fourth embodiment includes a fastening mechanism 50. The main body 10D includes a third engagement portion 14. An ink outlet portion 20D includes a fourth engagement portion 24 and a second sealing portion 26. The ink container 100 according to the fourth embodiment is otherwise structurally identical to the ink container 100 according to the third embodiment.

The third engagement portion 14 in the present embodiment is located between the open portion 11 and a first locking portion 51 on the outer periphery of the main body 10D. The fourth engagement portion 24 is located between the cylinder portion 21 and a second locking portion 52 on the inner periphery of the ink outlet portion 20D. The third engagement portion 14 engages with the fourth engagement portion 24. That is, the main body 10D engages with the ink outlet portion 20D via the third engagement portion 14 and the fourth engagement portion 24. In the present embodiment, the third engagement portion 14 and the fourth engagement portion 24 engage with each other, with one being screwed into the other, and as a result, the main body 10D engages with the ink outlet portion 20D. The third engagement portion 14 and the fourth engagement portion 24 are included in the liquid-non-contact section. This means that the third engagement portion 14 and the fourth engagement portion 24 are each made of a material containing recycled plastics.

The inner peripheral surface of the ink outlet portion 20D in the present embodiment includes a tubular wall 25 in the region where the fourth engagement portion 24 is located. The tubular wall 25 is part of the fourth engagement portion 24 and is included in the liquid-non-contact section. The inner peripheral surface of the tubular wall 25 is a crosshatched section in FIG. 9. The outer peripheral surface of the tubular wall 25 in the present embodiment is identical to the wall 23 (see FIG. 6) that is part of the first engagement portion 22. The inner and outer peripheral surfaces of the tubular wall 25 are both included in the liquid-non-contact section.

The open portion 11 is sealed with the second sealing portion 26 in a state in which the third engagement portion 14 and the fourth engagement portion 24 engage with each other. The second sealing portion 26 is an annular protrusion. The open portion 11 is sealed with the annular protrusion in close contact with the inner peripheral surface of the open portion 11. The second sealing portion 26 thus eliminates or reduces the possibility of leakage of ink such that the third engagement portion 14 and the fourth engagement portion 24 are kept from contact with ink. It is not required that the second sealing portion 26 be in close contact with the inner peripheral surface of the open portion 11. The second sealing portion 26 may be in close contact with the outer peripheral surface of the open portion 11. Alternatively, the second sealing portion 26 may be in close contact with both the inner and outer peripheral surfaces of the open portion 11, in which case the tip of the open portion 11 may be sealed with the second sealing portion 26 while being caught in the second sealing portion 26. Instead of being an annular protrusion, the second sealing portion 26 may be a packing that comes into contact with the tip face of the open portion 11.

The fastening mechanism 50 is a mechanism for fastening the ink outlet portion 20D to the main body 10D. The fastening mechanism 50 includes the first locking portion 51 on the outer side of the main body 10D and the second locking portion 52 on the ink outlet portion 20. The fastening mechanism 50 in the present embodiment is a ratchet mechanism. The first locking portion 51 is a pawl included in the ratchet mechanism. The second locking portion 52 consists of teeth included in the ratchet mechanism. When the ink outlet portion 20 is held with the outlet open portion of the cylinder portion 21 facing upward, the second locking portion 52 is located below the second sealing portion 26 and the fourth engagement portion 24. The second locking portion 52 extends along the entire inner periphery of the ink outlet portion 20. The second locking portion 52 includes a peripheral wall where the teeth are provided. The outer peripheral surface of the peripheral wall, as well as the inner peripheral surface of the peripheral wall, may be included in the second locking portion 52.

In the present embodiment, the ink outlet portion 20D engages with the main body 10D when the third engagement portion 14 and the fourth engagement portion 24 engage with each other, with one being screwed into the other. As a result, the first locking portion 51 and the second locking portion 52 engage with each other to allow rotation in one direction while preventing rotation in the opposite direction that is the unscrewing direction. In this way, the ink outlet portion 20D is fastened to the main body 10D. In the fastened state, the first locking portion 51 and the second locking portion 52 are located on the outer side of the main body 10D. That is, the fastening mechanism 50 is located on the outer side of the main body 10D in the state in which the ink outlet portion 20D is fastened to the main body 10D by the fastening mechanism 50. The fastening mechanism 50 is thus included in the liquid-non-contact section. This means that the fastening mechanism 50 is made of a material containing recycled plastics. It is not required that the fastening mechanism 50 be a ratchet mechanism. For example, the fastening mechanism 50 may be a snap-fit.

In the ink container 100 according to the fourth embodiment described above, the fastening mechanism 50 that does not come into contact with ink is made of a material containing recycled plastics. The material containing recycled plastics is therefore kept from contact with ink. This eliminates or reduces the possibility that the material will become dissolved through contact with ink. Thus, the material concerned is less likely to have adverse effects on the ink kept in the container.

Furthermore, the third engagement portion 14 and the fourth engagement portion 24 that do not come into contact with ink are each made of a material containing recycled plastics. The material containing recycled plastics is therefore kept from contact with ink. This eliminates or reduces the possibility that the material will become dissolved through contact with ink. Thus, the material concerned is less likely to have adverse effects on the ink kept in the container.

### E. Fifth Embodiment

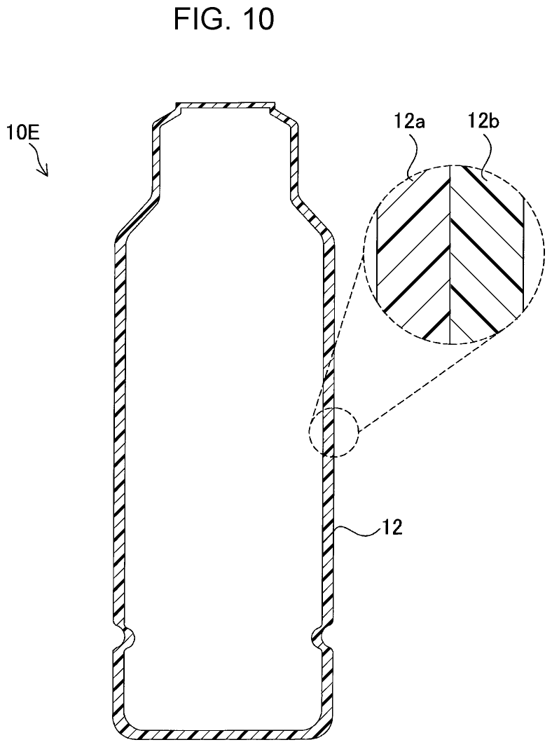

FIG. 10 is a sectional view of a main body 10E in a fifth embodiment. A surface layer 12b as a first outer layer of the side portion 12 is included in the liquid-non-contact section. The ink container 100 according to the fifth embodiment is otherwise structurally identical to the ink container 100 according to the first embodiment. The term “surface layer” herein refers to an outer layer facing outward. Conversely, the term “inner layer” herein refers to a layer facing the interior of the ink container 100.

The side portion 12 in the present embodiment is a double-layer structure composed of an inner layer 12a and the surface layer 12b. The inner layer 12a is made of a virgin plastic material, whereas the surface layer 12b is made of a material containing recycled plastics.

The ink container 100 according to the fifth embodiment in which the side portion 12 is a double-layer structure as described above is tougher than it would be if the side portion 12 were a single-layer structure. This eliminates or reduces the possibility that the force applied to the side portion 12 at the time when the user holds the ink container will cause the ink container to become deformed or will cause ink from spurting out of the container. Furthermore, the proportion of the material containing recycled plastics in the ink container is higher than it would be if the lamination were made solely of a virgin plastic material.

### F. Sixth Embodiment

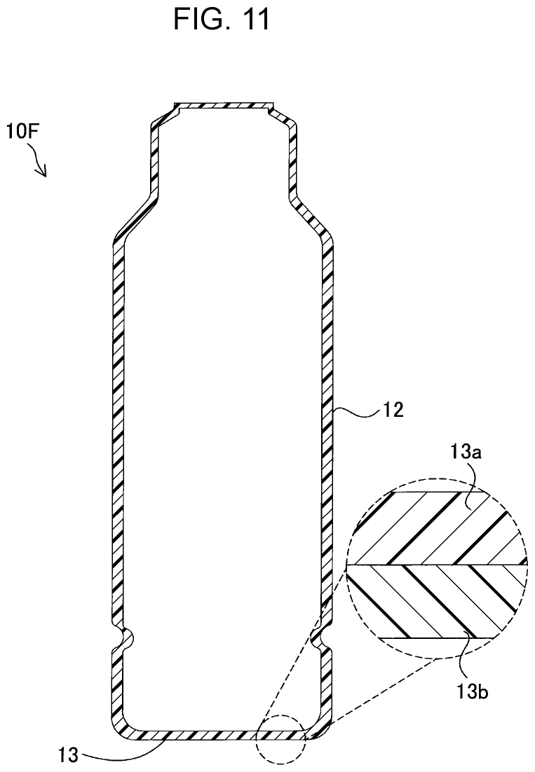

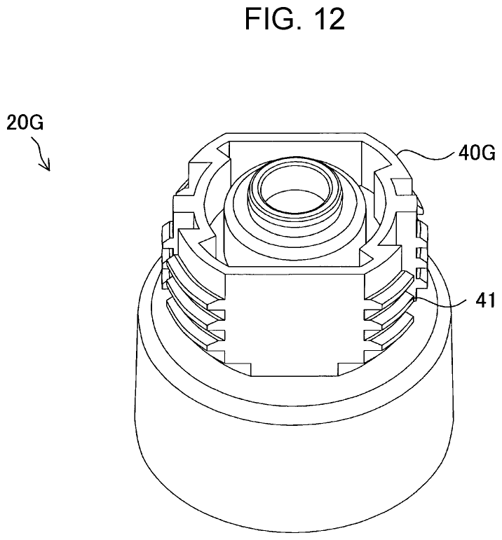

FIG. 11 is a sectional view of a main body 10F in a sixth embodiment. A surface layer 13b as a second outer layer of the bottom portion 13 is included in the liquid-non-contact section. The ink container 100 according to the sixth embodiment is otherwise structurally identical to the ink container 100 according to the fifth embodiment.

The bottom portion 13 in the present embodiment is a double-layer structure composed of an inner layer 13a and the surface layer 13b. The inner layer 13a is made of a virgin plastic material, whereas the surface layer 13b is made of a material containing recycled plastics. The surface layer 13b of the bottom portion 13 and the surface layer 12b of the side portion 12 extend without a gap therebetween.

The ink container 100 according to the sixth embodiment in which the bottom portion 13 is a double-layer structure as described above is tougher than it would be if the bottom portion 13 were a single-layer structure. In addition, the main body 10 is reinforced at corners where the bottom portion 13 and the side portion 12 are coupled to each other; otherwise, the main body 10 would be likely to become thinned at the corners especially when being formed by blow molding. Furthermore, the proportion of the material containing recycled plastics in the ink container is higher than it would be if the lamination were made solely of a virgin plastic material.

### G. Other Embodiments

(G1) The main body 10 of the ink container 100 according to the embodiment described above may bear a label on its periphery, where the label may be part of the liquid-non-contact section.
(G2) The liquid-contact section and the liquid-non-contact section in the embodiment described above may be formed as a one-piece member or a combination of separate members. When the liquid-contact section and the liquid-non-contact section are separate members, it is preferable that they be combined together without an adhesive.
(G3) The main body 10 and the ink outlet portion 20 in any one of the first embodiment, the second embodiment, the third embodiment, the fifth embodiment, and the sixth embodiment may constitute a single undivided piece.
(G4) It is not required that the ink container 100 according to any one of the second embodiment, the fourth embodiment, the fifth embodiment, and the sixth embodiment be fitted with the cap 30.
(G5) In the second embodiment, identification portions 40 of different shapes are provided for different types of ink. In some embodiments, identification portions 40 of different colors are provided for different types of ink. For example, the color of each identification portion 40 is consistent with the color of the ink kept in the container. In this case, the color of the ink kept in the container is readily discernible to the eyes.
(G6) As illustrated in FIG. 12 in relation to the second embodiment described above, an identification portion 40G may extend either along part of or all along the periphery of an ink outlet portion 20G. The identification portion 40G may include a fifth engagement portion 41, which engages with the cap 30. The fifth engagement portion 41 is associated with the first engagement portion 22 illustrated in FIG. 6.
(G7) The ink container 100 according to the fourth embodiment described above includes the fastening mechanism 50, the third engagement portion 14, the fourth engagement portion 24, and the second sealing portion 26. Alternatively, the fastening mechanism 50 of the ink container 100 may be provided alone; that is, the third engagement portion 14 and the fourth engagement portion 24 are optional. It is not required that the ink container 100 include the fastening mechanism 50.
(G8) In both the fifth and sixth embodiments described above, the side portion 12 is a double-layer structure. Alternatively, the side portion 12 may be a multilayer structure composed of three or more layers. In the sixth embodiment described above, the bottom portion 13 is a double-layer structure. Alternatively, the bottom portion 13 may be a multilayer structure composed of three or more layers. It is not required that both the side portion 12 and the bottom portion 13 be multilayer structures; that is, only the bottom portion 13 may be a multilayer structure.
(G9) In both the fifth and sixth embodiments described above, the entirety of the surface layer 12b of the side portion 12 is included in the liquid-non-contact section. Alternatively, at least a part of the surface layer 12b of the side portion 12 may be included in the liquid-non-contact section.
(G10) The entirety of the wall of the ink outlet portion 20 in the first embodiment described above may be a lamination composed of an inner layer and a surface layer. The same holds true for the second embodiment, the third embodiment, the fifth embodiment, and the sixth embodiment. Alternatively, part of the ink outlet portion 20 or, more specifically, the wall of the cylinder portion 21 having an ink outlet portion channel defined therein may be a lamination composed of an inner layer and a surface layer. The wall may be formed by, for example, dual-material molding using mutually different materials. For example, the inner layer included in the liquid-contact section may be made of a virgin polypropylene material, and the surface layer included in the liquid-non-contact section may be made of recycled plastics other than polypropylene. The main body 10E in the fifth embodiment and the main body 10F in the sixth embodiment each may be formed by, for example, dual-material molding, in which case the inner layer may be made of a virgin polypropylene material, and the surface layer may be made of a material containing recycled plastics other than polypropylene. Furthermore, the ink outlet portion 20 and the main body 10 may be molded in one piece in the manner described above.

### H. Other Embodiments

The present disclosure is not limited to the embodiments described above and may be implemented in various forms within a range not departing from the spirit of the present disclosure. For example, the technical features of each embodiment that correspond to the respective technical features described as each aspect in the summary can be interchanged or combined as appropriate to solve some or all of the aforementioned problems or to achieve some or all of the aforementioned effects. Any of the technical features that is not herein described as an absolute must may be omitted where appropriate.
(1) According to an embodiment of the present disclosure, an ink container is provided. The ink container includes a liquid-contact section and a liquid-non-contact section. The liquid-contact section is made of a virgin plastic material and is to be in contact with ink in the ink container. The liquid-non-contact section is made of a material containing recycled plastics and is to be kept from contact with the ink. The embodiment in which a material containing recycled plastics that can dissolve in ink is kept from contact with ink eliminates or reduces the possibility that the ink container will become dissolved through contact with ink.
(2) The ink container according to the embodiment described above may further include: a main body configured to keep the ink therein; an ink outlet portion linked to the main body to enable the ink to flow out of the ink container; and a cap including a first sealing portion with which the ink outlet portion is sealed. The first sealing portion may be part of the liquid-contact section, and the cap except for the first sealing portion may be part or all of the liquid-non-contact section. When the first sealing portion is part of the liquid-contact section, and the cap except for the first sealing portion is part or all of the liquid-non-contact section, the material containing recycled plastics is kept from contact with ink. The ink container according to the present embodiment therefore eliminates or reduces the possibility that the cap will become dissolved through contact with ink. Thus, the material concerned is less likely to have adverse effects on the ink kept in the container.
(3) The ink container according to the embodiment described above may further include: a main body configured to keep the ink therein; an ink outlet portion linked to the main body to enable the ink to flow out of the ink container; and an identification portion that is disposed in at least a part of an outer region of the ink outlet portion to enable identification of a type of the ink and that is part or all of the liquid-non-contact section. In the ink container according to the present embodiment, the identification portion that does not come into contact with ink is made of a material containing recycled plastics. The material containing recycled plastics is therefore kept from contact with ink. This eliminates or reduces the possibility that the material will become dissolved through contact with ink. Thus, the material concerned is less likely to have adverse effects on the ink kept in the container.
(4) The ink container according to the embodiment described above may further include: a main body configured to keep the ink therein; an ink outlet portion linked to the main body to enable the ink to flow out of the ink container; and a cap configured to be attached to the ink outlet portion. The ink outlet portion may include a first engagement portion that extends along at least a part of a periphery of the ink outlet portion and that is part or all of the liquid-non-contact section. The cap may include a second engagement portion that is configured to be engaged with the first engagement portion and that is part or all of the liquid-non-contact section. In the ink container according to the present embodiment, the first engagement portion and the second engagement portion that do not come into contact with ink are each made of a material containing recycled plastics. The material containing recycled plastics is therefore kept from contact with ink. This eliminates or reduces the possibility that the material will become dissolved through contact with ink. Thus, the material concerned is less likely to have adverse effects on the ink kept in the container.
(5) The ink container according to the embodiment described above may further include: a main body configured to keep the ink therein; an ink outlet portion that is separate from the main body and that is linked to the main body to enable the ink to flow out of the ink container; and a fastening mechanism configured to fasten the ink outlet portion to the main body. The fastening mechanism may include a first locking portion disposed on an outer side of the main body and a second locking portion that is disposed on the ink outlet portion and that is configured to be engaged with the first locking portion. The second locking portion may be located on the outer side of the main body in a fastened state in which the ink outlet portion is fastened to the main body with the first and second locking portions engaged with each other. The fastening mechanism may be part or all of the liquid-non-contact section. In the ink container according to the present embodiment, the fastening mechanism that does not come into contact with ink is made of a material containing recycled plastics. The material containing recycled plastics is therefore kept from contact with ink. This eliminates or reduces the possibility that the material will become dissolved through contact with ink. Thus, the material concerned is less likely to have adverse effects on the ink kept in the container.
(6) The ink container according to the embodiment described above may further include: a main body configured to keep the ink therein; and an ink outlet portion that is separate from and removably attached to the main body and that is linked to the main body to enable the ink to flow out of the ink container. The main body may include an open portion linked to the ink outlet portion and a third engagement portion that is located on an outer side of the main body and that is part or all of the liquid-non-contact section. The ink outlet portion may include: a fourth engagement portion that is configured to be engaged with the third engagement portion and that is part or all of the liquid-non-contact section; and a second sealing portion with which the open portion is sealed in a state in which the third engagement portion and the fourth engagement portion are engaged with each other. In the ink container according to the present embodiment, the third engagement portion and the fourth engagement portion that do not come into contact with ink are each made of a material containing recycled plastics. The material containing recycled plastics is therefore kept from contact with ink. This eliminates or reduces the possibility that the material will become dissolved through contact with ink. Thus, the material concerned is less likely to have adverse effects on the ink kept in the container.
(7) The ink container according to the embodiment described above may further comprise: a main body configured to keep the ink therein; and an ink outlet portion linked to the main body to enable the ink to flow out of the ink container. The main body may have a bottom portion and a side portion. The ink outlet portion and the bottom portion may be coupled to each other with the side portion extending therebetween. At least a part of the side portion may have a wall of a plurality of layers, one layer of which is a first outer layer facing outward. The first outer layer may constitute part or all of the liquid-non-contact section. The ink container according to the present embodiment in which at least a part of the side portion having a wall of a plurality of layers is tougher than it would be if the side portion were a single-layer structure.
(8) The ink container according to the embodiment described above may further comprise: a main body configured to keep the ink therein; and an ink outlet portion linked to the main body to enable the ink to flow out of the ink container. The main body may have a bottom portion and a side portion. The ink outlet portion and the bottom portion may be coupled to each other with the side portion extending therebetween. At least a part of the bottom portion may have a wall of a plurality of layers, one layer of which is a second outer layer facing outward. The second outer layer may constitute part or all of the liquid-non-contact section. The ink container according to the present embodiment in which at least a part of the bottom portion having a wall of a plurality of layers is tougher than it would be if the bottom portion were a single-layer structure. (9) The ink container according to the embodiment described above may further comprise: a main body configured to keep the ink therein; and an ink outlet portion linked to the main body to enable the ink to flow out of the ink container. The main body may have a bottom portion and a side portion. The ink outlet portion and the bottom portion may be coupled to each other with the side portion extending therebetween. At least a part of the side portion may have a wall of a plurality of layers, one layer of which is a first outer layer facing outward. At least a part of the bottom portion may have a wall of a plurality of layers, one layer of which is a second outer layer facing outward. The first and second outer layers may be continuous with each other and may constitute part or all of the liquid-non-contact section. The ink container according to the present embodiment is tougher than it would be if the side and bottom portions were a single-layer structure.
(10) The liquid-contact section and the liquid-non-contact section of the ink container according to the embodiment described above may be unitarily formed, that is, formed as a one-piece member or a combination of separate members. That is, the liquid-contact section and the liquid-non-contact section of the ink container according to the present embodiment can be formed as either a one-piece member or a combination of separate members. For example, the liquid-contact section and the liquid-non-contact section may be formed as a one-piece member by dual-material molding. Alternatively, the liquid-contact section and the liquid-non-contact section may be formed by combining separate members by means of, for example, adhesion, staking, or engagement. The separate members detachably combined together by means of, for example, staking or engagement are replaceable and recyclable. For example, the fastening member can restore its fastening function through the replacement of a worn-out member with a new one.

Not all of the constituent components mentioned above in relation to each of the embodiments of the present disclosure are essential. Some of the constituent components may be changed, omitted, replaced with newly adopted components, or freed from some of the limitations to solve some or all of the aforementioned problems or to achieve some or all of the effects described herein. For example, some or all of the technical features of one embodiment of the present disclosure described above and some or all of the technical features of another embodiment of the present disclosure described above may be combined into an independent embodiment of the present disclosure to solve some or all of the aforementioned problems or to achieve some or all of the effects described herein.

While the embodiments of the present disclosure have been described above, the present disclosure can also be implemented as, for example, a method for manufacturing ink containers.

What is claimed is:

1. An ink container comprising:
a liquid-contact section that is made of a virgin plastic material and that is to be in contact with ink in the ink container; and
a liquid-non-contact section that is made of a material containing recycled plastics and that is to be kept from contact with the ink.

2. The ink container according to claim 1, further comprising:
a main body configured to keep the ink therein;
an ink outlet portion linked to the main body to enable the ink to flow out of the ink container; and
a cap including a first sealing portion with which the ink outlet portion is sealed, wherein
the first sealing portion is part of the liquid-contact section, and
the cap except for the first sealing portion is part or all of the liquid-non-contact section.

3. The ink container according to claim 1, further comprising:
a main body configured to keep the ink therein;
an ink outlet linked to the main body to enable the ink to flow out of the ink container; and
an identification portion that is disposed in at least a part of an outer surface region of the ink outlet portion to enable identification of a type of the ink and that is part or all of the liquid-non-contact section.

4. The ink container according to claim 1, further comprising:
a main body configured to keep the ink therein;
an ink outlet portion linked to the main body to enable the ink to flow out of the ink container; and
a cap configured to be attached to the ink outlet portion, wherein
the ink outlet portion includes a first engagement portion that extends along at least a part of a periphery of the ink outlet portion and that is part or all of the liquid-non-contact section, and
the cap includes a second engagement portion that is configured to be engaged with the first engagement portion and that is part or all of the liquid-non-contact section.

5. The ink container according to claim 1, further comprising:
a main body configured to keep the ink therein;
an ink outlet portion that is separate from the main body and that is linked to the main body to enable the ink to flow out of the ink container; and
a fastening mechanism configured to fasten the ink outlet portion to the main body, wherein
the fastening mechanism includes
a first locking portion disposed on an outer side of the main body, and
a second locking portion that is disposed on the ink outlet portion and that is configured to be engaged with the first locking portion, the second locking portion being located on the outer side of the main body in a fastened state in which the ink outlet portion is fastened to the main body with the first and second locking portions engaged with each other, and
the fastening mechanism is part or all of the liquid-non-contact section.

6. The ink container according to claim 1, further comprising:
a main body configured to keep the ink therein; and
an ink outlet portion that is separate from and removably attached to the main body and that is linked to the main body to enable the ink to flow out of the ink container, wherein
the main body includes
an open portion linked to the ink outlet portion, and
a third engagement portion that is located on an outer side of the main body and that is part or all of the liquid-non-contact section, and
the ink outlet portion includes
a fourth engagement portion that is configured to be engaged with the third engagement portion and that is part or all of the liquid-non-contact section, and
a second sealing portion with which the open portion is sealed in a state in which the third engagement portion and the fourth engagement portion are engaged with each other.

7. The ink container according to claim 1, further comprising:
a main body configured to keep the ink therein; and
an ink outlet portion linked to the main body to enable the ink to flow out of the ink container, wherein
the main body has a bottom portion and a side portion, the ink outlet portion and the bottom portion being coupled to each other with the side portion extending therebetween,
at least a part of the side portion has a wall of a plurality of layers, one layer of which being a first outer layer facing outward, and
the first outer layer constitutes part or all of the liquid-non-contact section.

8. The ink container according to claim 1, further comprising:
a main body configured to keep the ink therein; and
an ink outlet portion linked to the main body, wherein
the main body has a bottom portion and a side portion, the ink outlet portion and the bottom portion being coupled to each other with the side portion extending therebetween,
at least a part of the bottom portion has a wall of a plurality of layers, one layer of which being a second outer layer facing outward, and
the second outer layer constitutes part or all of the liquid-non-contact section.

9. The ink container according to claim 1,
further comprising:
a main body configured to keep the ink therein; and
an ink outlet portion linked to the main body, wherein
the main body has a bottom portion and a side portion, the ink outlet portion and the bottom portion being coupled to each other with the side portion extending therebetween,
at least a part of the side portion has a wall of a plurality of layers, one layer of which being a first outer layer facing outward,
at least a part of the bottom portion has a wall of a plurality of layers, one layer of which being a second outer layer facing outward, and
the first and second outer layers are continuous with each other and constitute part or all of the liquid-non-contact section.

10. The ink container according to claim 1, wherein the liquid-contact section and the liquid-non-contact section are unitarily formed or formed as a combination of separate members.
